(19) United States
(12) Patent Application Publication
(10) Pub. No.: US 2021/0190346 A1
(43) Pub. Date: Jun. 24, 2021

(54) Controllable Ultra-Violet Air Disinfection System and Method

(71) Applicant: MHT Holdings LLC, Staten Island, NY (US)

(72) Inventors: Akram Khalis, Roselle, NJ (US); Hamid Pishdadian, Warwick, RI (US); Steve Silverman, Monmouth Beach, NJ (US); Mike Tennyson, Wall, NJ (US)

(73) Assignee: MHR Holdings LLC, Staten Island, NY (US)

(21) Appl. No.: 17/025,358

(22) Filed: Sep. 18, 2020

(51) Int. Cl. F24F 8/22; F24F 11/58; F24F 11/64; F24F 11/79

(52) U.S. Cl. CPC F24F 8/22; F24F 11/58; F24F 2110/50; F24F 11/79; F24F 11/64

(57) ABSTRACT

A UV air disinfection system customizable for various different types of target pathogens by controlling the duration and intensity of UV exposure. A controller using table lookup adjusts the duration and intensity for a particular air sample at wavelengths proven to deactivate the target pathogen(s). An ambient air sample is brought into a chamber of known volume, and the air is exposed to UV radiation for a duration and intensity specified by a lookup table for the target pathogen(s). This air is then expelled into the room, and another sample is taken. This cyclic operation guarantees a predetermined deactivation percentage of the target pathogen in the expelled air. The process is repeated over and over at a rate designed to disinfect a room in a chosen time.

### BACKGROUND

### Field of the Invention

The present invention relates to air disinfection and more particularly to an ultra-violet light air disinfecting system that is used cyclically to kill or inactivate almost all living organisms in each sample volume of air passed through the system.

### Description of the Problem Solved

Room air is known to contain numerous living organisms including mold, viruses, and bacteria. In particular, room air may contain droplet particles emitted by humans or animals that in turn contain millions of viruses or bacteria. It is known that these droplets originate primarily from coughing, sneezing or talking. Typically, exposure of mucus membranes to these droplets (especially in the nose and throat) is the primary mechanism that spreads these pathogens. This is especially true for viruses including influenza and COVID-19.

It is known in the art that exposure to ultra-violet light (UV) kills pathogens whether they are in droplets or not. Various studies have yielded tables of kill times for in UV light for different pathogens (Note: in this disclosure the word “kill” means that the pathogen is deactivated to the point where it cannot reactivate when expelled back into ambient air). Prior art air cleaners are known that pass moving air past one or more UV lamps. However, if an air sample is not in the UV beam long enough, there will not be a total kill or deactivation of all the living organisms present in the sample. It is known that different exposures are needed for different pathogens. It would be extremely advantageous to have an ultra-violet air disinfection system that passed the maximum amount of air possible while killing a very high percentage of living organisms (at least 99% of target pathogens present). It would also be extremely advantageous to be able to target particular pathogens by supplying parameters remotely through a network. While COVID-19 is the current concern, environments such as hospitals and in particular surgical suites, may also want to assure that other pathogens such as tuberculosis (TB), influenza (Flu), C-Diff, Staff and many others are killed or deactivated.

Prior art UV systems have also typically used mercury vapor lamps to produce the light. However, mercury vapor lamps have relatively short lives and are difficult to control. In particular, brightness is difficult to adjust or change. In recent years, UV light-emitting diodes (LEDs) have been replacing and complementing mercury vapor lamps because of their extended lifetimes and control capabilities.

### SUMMARY OF THE INVENTION

The present invention relates to a UV air disinfection system that is capable of being customized for various different types of pathogens by controlling the duration and intensity of the exposure. A controller and memory with table lookup capability adjusts the duration and intensity of the exposure for a particular air sample at wavelengths proven to kill the target pathogen(s). An ambient air sample is brought into a chamber of known volume. The chamber is closed, and the air is exposed to UV radiation for a duration and intensity specified by a lookup table for the target pathogen(s). This air is then expelled into the room, and another sample is taken. This cyclic operation guarantees a predetermined kill percentage of the target pathogen in the expelled air. The parameters including exchange rate and intensity can be changed to meet changing conditions or requirements. Parameters including target pathogen types, air exchange rate and the like can be supplied remotely over a network. Different systems with larger or smaller chambers and more or less LEDs can be supplied for different sized spaces.

### DESCRIPTION OF THE FIGURES

Attention is now directed to several figures that illustrate features of the present invention.

FIG. 1 is a drawing of a chamber containing UV LEDs.

FIG. 2 is a block diagram of an embodiment of the present invention.

FIG. 3 is a block diagram showing details of an embodiment of lookup tables.

FIG. 4 is an example of the data in the lookup tables.

Several illustrations and drawings have been presented to aid in understanding the present invention. The scope of the present invention is not limited to what is shown in the figures.

### DESCRIPTION OF THE PREFERRED EMBODIMENTS

The present invention relates to an air disinfection system that adjusts duration and intensity of UV exposure in a chamber to guarantee a desired (very high} percentage kill of pathogens or other living organisms in room air. Ambient air is shuttled through the chamber in steps or cycles with pauses for UV light exposure determined by a controller. Expelled air is disinfected to a target level for one or more target pathogens.

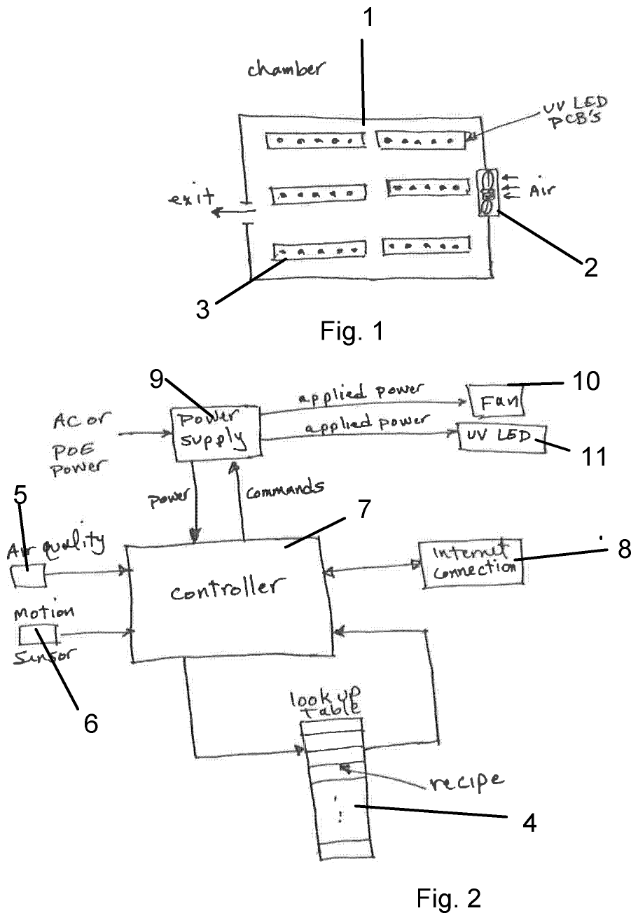

FIG. 1 shows an embodiment of the present invention. A chamber 1 holds air to be treated. At the start of each cycle, a calibrated fan 2 introduces a precise volume of air into the chamber to be processed. The exact volume is determined by the chamber size. One or more printed circuit boards 3 holds groups of UV LEDs.

The fan is activated for a very precise duration so that only the existing air from the previous cycle is expelled, while just enough unprocessed ambient air is drawn in to exactly fill the chamber. Once the fan is stopped, its direction of rotation can be reversed to stop the flow momentum of the incoming air, or alternatively, the chamber can be sealed by mechanical means.

Next, the UV LEDs are turned on and kept on at an intensity that is dictated by a recipe kept in a lookup table 4 as shown in FIG. 2. The lookup table contains information specific to various pathogens, and the size of the particular chamber. The correct duration and intensity for each cycle is chosen from the table based on the duration/intensity needed to kill the toughest pathogen being targeted.

The system ensures the air sample is kept in the light beam long enough so that the target pathogens are deactivated in the chamber to an extent that will not allow them to be reactivated when the air is expelled and re-exposed to visible light in the room or space.

FIG. 2 also shows a block diagram of the system able to be dynamically programmed using the Internet or other network to change operational parameters—in particular, the list of targeted pathogens. Room sensors such as air quality sensors 5 and/or motion sensors 6 can be used to measure air quality as well occupancy of the space being disinfected. This information may be fed via the network to the controller in real time. The controller can respond by increasing or decreasing the rate of air interchange by adjusting the UV intensity and fan speed. The controller can optionally increase or decrease the air processing rate based on room occupancy or room air quality.

The controller 7 can be any microcontroller, microprocessor, processor, or any other computer or circuit capable of controlling the fan and the LEDs as well as performing table lookup including digital and/or analog circuits. A network connection 8 allows external monitoring and control of the unit including diagnostics. A wireless connection can be made via WiFi, Bluetooth™ or any other wireless technique. A power supply 9 is connected to a fan driver or smart-fan 10 and to the UV LED driver 11. The lookup tables 16 are typically stored in a memory or other storage device. This can be controller internal memory or an external memory known in the art. Optionally, the lookup tables can be stored on a remote computer or server with contents being supplied over the network as needed.

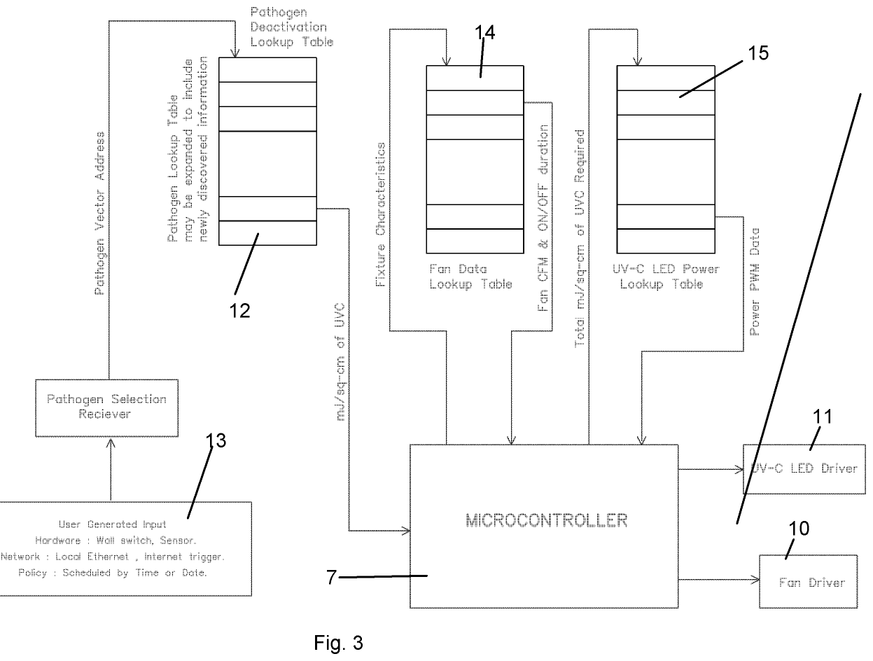

FIG. 3 is a block diagram showing an embodiment of the lookup tables. Here, the controller 7 looks up the particular pathogen in a pathogen table 12 using a pathogen address vector chosen based on user-generated input 13. This user-generated input can be a simple wall switch, a sensor output, or an input from the network. It can also be chosen according to a particular schedule for the room or space based on time and/or date. The result is the UV light intensity in mJ/cm**2 or other measure.

A second table 14 contains fan data. This can be based on chamber characteristics and the particular fan used. The output from this table is fan cubic foot per minute (CFM) and on/off duration of the fan as well as optionally rotation reversal time.

A third table is the LED UV power lookup table 15. The total UV light intensity in mJ/cm**2 is converted to LED pulse width modulation (PWM) data. In this embodiment, LED intensity is controlled by pulse width and repetition rate; however, any method of controlling LED intensity is within the scope of the present invention.

The controller 7 takes these results from the tables and controls the fan cycles and light intensities to achieve the desired disinfection and exchange rate through the fan driver 10 and the LED driver 11.

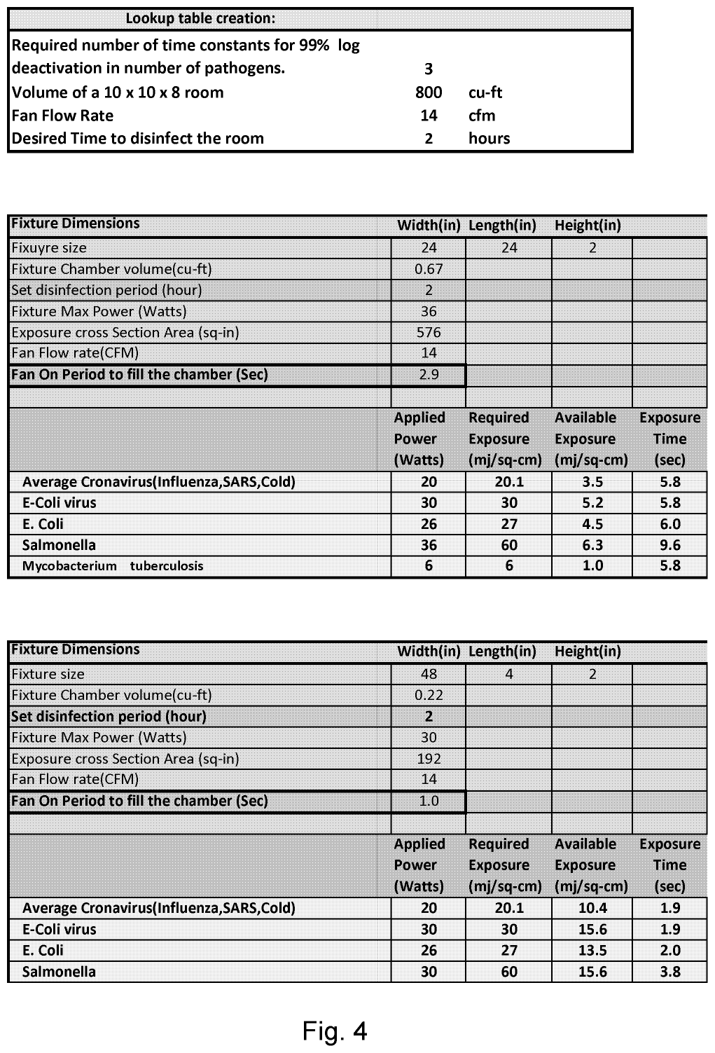

FIG. 4 shows data that may appear in sample pathogen lookup tables for two different sized chambers, namely 24×24×24 inch and 48×4×2 inch. These are example dimensions. Any size chamber may be used as long as it can be flooded with UV light, and the fan can control the airflow. The particular tables shown in FIG. 4 are also for example only. They show requirements for only four pathogens each. With the larger chamber in the first table, the required exposure for SARS is 20.1 mJ/cm**2. With an exposure capability of 3.5 mJ/cm**2/sec, the required duration is 5.8 seconds. Thus, with a fan flow rate of 14 CFM, a 10×10×8 foot room can be disinfected in 2 hours. Typically, the time desired to disinfect the room is chosen in advance (say 2 hours), and the output parameters are adjusted accordingly. It should be noted that various lookup tables may be chosen based on chamber size and other parameters.

The present invention presents an adjustable method of disinfecting a room by purifying air using UV LEDs and smart air flow control. Users can optionally input desired pathogen and other control parameters via a network connection such as the Internet. The connection can be wireless.

Several descriptions and illustrations have been presented to aid in understanding the present invention. One with skill in the art will realize the numerous changes and variations may be made without departing from the spirit of the invention. Each of these changes and variations is within the scope of the present invention.

We claim:

1. An air disinfection system comprising:
a controller;
a chamber;
a controllable fan configured to draw a predetermined amount of air into the chamber, hold the predetermined amount of air in the chamber for a particular duration, and then expel the predetermined amount of air from the chamber;
a plurality of intensity controlled ultra-violet (UV) light emitting diodes (LEDs) located in the chamber;
the controller constructed to control the controllable fan and the intensity-controlled UV LEDs to hold the predetermined amount of air in UV light of a particular intensity long enough to deactivate a target percentage of target pathogens in the predetermined amount of air.

2. The system of claim 1, wherein the particular duration and particular intensity are stored in one or more lookup tables.

3. The system of claim 2, wherein the lookup tables are addressed according to different pathogen types.

4. The system of claim 3, wherein the lookup tables are chosen according to chamber size.

5. The system of claim 1, wherein the controllable fan is reversible.

6. The system of claim 1, wherein the target percentage is 99% or greater.

7. The system of claim 1, wherein the lookup tables are stored in an internal memory in the controller.

8. The system of claim 1, further comprising a network interface constructed to receive user instructions from a remote location.

9. The system of claim 8, wherein the user instructions include a list of target pathogens.

10. The system of claim 1, further comprising at least one room occupation sensor or air quality sensor in communication with the controller.

11. The system of claim 10, wherein the controller increases or decreases an air processing rate based on room occupancy or air quality.

12. An air disinfection system comprising, in combination:
a controllable fan constructed to drive air into and out of an enclosed volume;
a plurality of ultra-violet (UV) light-emitting diodes (LEDs) configured to project UV light into the enclosed volume;
wherein, the fan is controlled to fill the enclosed volume with air, hold the air in the volume for a particular duration exposing the air in the volume to UV light of a particular intensity, and then expel the air from the enclosed volume.

13. The system of claim 12, wherein the particular duration and the particular intensity are determined from one or more lookup tables.

14. The system of claim 13, wherein at least one of the one or more lookup tables is addressed by a target pathogen type.

15. A method of disinfecting air in a room comprising:
a) causing a predetermined amount of air to enter a chamber;
b) holding the predetermined amount of air in the chamber in an ultra-violet (UV) light beam of a particular intensity for a duration sufficient to deactivate a chosen pathogen type;
c) discharging the predetermined amount of air from the chamber;
d) repeating steps a) through c).

16. The method of claim 15, wherein the duration and particular intensity are found in a lookup table.

17. The method of claim 16, wherein the lookup table is addressed by the chosen pathogen type.

18. The method of claim 16, wherein the lookup table is arranged according to chamber volume.

19. The method of claim 15, wherein the UV light beam is produced by a plurality of intensity-controlled light-emitting diodes (LEDs).

20. The method of claim 19, wherein the LEDs are pulse-width modulated (PWM).
